(19) United States
(12) Patent Application Publication
(10) Pub. No.: US 2015/0095101 A1
(43) Pub. Date: Apr. 2, 2015

(54) METHOD AND SYSTEM FOR POPULATING REQUIREMENTS

(71) Applicant: Omnex Systems, LLC, Ann Arbor, MI (US)

(72) Inventors: Chandran Kymal, Ann Arbor, MI (US); Gregory Francis Gruska, Farmington Hills, MI (US)

(73) Assignee: Omnex Systems, LLC, Ann Arbor, MI (US)

(21) Appl. No.: 14/042,851

(22) Filed: Oct. 1, 2013

(51) Int. Cl. G06Q 10/06

(52) U.S. Cl. CPC G06Q 10/0635
USPC 705/7.28

(57) ABSTRACT

A non-transitory machine readable storage medium storing instructions that, when executed, cause a processor to perform a method of receiving input defining one or more requirements for a product. The method may generate one or more cross-reference matrices from the one or more requirements based on a hazard analysis risk assessment. The method may generate a parent-child structure for the one or more cross-reference matrices and populate a requirement file based on the cross-reference matrices. The method may generate a risk prevention analysis file based on input from the requirement file and one or more linkages between the one or more requirements and the parent-child structure, and output the risk prevention analysis file. The method may output the risk prevention analysis file as a tree structure and have a tool to enable a user to scroll through the tree structure.

### TECHNICAL FIELD

The illustrative embodiments generally relates to methods and systems for knowledge management throughout the entire life cycle of a product for use in product and process optimization, problem solving, and the development of other products and services.

### BACKGROUND

Engineering drawings and requirements describe the necessary function and features of a product, service, component, and/or system to a product development organization. The product development organization will develop and use the requirements when conceiving, designing, implementing, manufacturing, and operating the product. Product development organizations may have several spreadsheets, documents, directories, and databases that contain all the materials required by engineering drawings, requirements, process specifications, design standards, and purchase orders for the manufacture of a product.

The requirements are established as a basis for an agreement between the stakeholders and the developers on what the product is to do. The requirements are often organized to allow the engineering organization to focus on what should be achieved and are used when determining how it should be achieved. The requirements will be cross-referenced in several engineering analysis tools, documents, validation, and verification reports. If the requirements are written well and communicated to the engineering organization at every level, then the development effort will see a reduction in rework and an improvement in quality. Additional benefits of having requirements communicated throughout the engineering organization will impact quality, engineering costs, and development timing of the product.

A product development organization may develop requirements using several tools and systems while storing this information on several computers and/or databases. A challenge for many organizations is a requirements flow down approach to ensure these requirements are being cross-referenced in each system, subsystem, and/or component during design, development, and verification of the product. Another challenge for many organizations is the generation of one or more risk assessment documents when trying to perform analysis on a product and/or process. To ensure communication of requirements across the product development organization large amounts of human labor have been expended to manually keep track of the design, development, risk analysis, and manufacturing relationships a product demands.

### SUMMARY

In a first illustrative embodiment, a non-transitory machine readable storage medium storing instructions that, when executed, cause a processor to perform a method of receiving input defining one or more requirements for a product. The method may generate one or more cross-reference matrices from the one or more requirements based on an hazard analysis risk assessment. The method may generate a parent-child structure for the one or more cross-reference matrices and populate a requirement file based on the cross-reference matrices. The method may generate a risk prevention analysis file based on input from the requirement file and one or more linkages between the one or more requirements and the parent-child structure, and output the risk prevention analysis file. The method may output the risk prevention analysis file as a tree structure and have a tool to enable a user to scroll through the tree structure.

In a second illustrative embodiment, a system having one or more processors configured to receive input defining one or more requirements for a product. The system may generate one or more cross-reference matrices from the one or more requirements based on a hazard analysis risk assessment. The system may generate a parent-child structure for the one or more cross-reference matrices and populate a requirement file based on the cross-reference matrices. The system may generate a risk prevention analysis file based on input from the requirement file and one or more linkages between the one or more requirements and the parent-child structure, and output the risk prevention analysis file. The system may output the risk prevention analysis as a tree structure including, but not limited to, a fault tree analysis. The system may have a tool to enable a user to scroll through the tree structure.

In a third illustrative embodiment, a method of receiving input defining one or more requirements for a product and generating one or more cross-reference matrices from the one or more requirements based on an hazard analysis risk assessment. The method may generate a parent-child structure for the one or more cross-reference matrices and populate a requirement file based on the cross-reference matrices. The method may generate a risk prevention analysis file based on input from the requirement file and one or more linkages between the one or more requirements and the parent-child structure. The method may output the risk prevention analysis file, including a tree structure including, but not limited to, a fault tree analysis. The method may have a tool to enable a user to scroll through the tree structure.

### BRIEF DESCRIPTION OF THE DRAWINGS

FIG. 1 is a diagram of a web-based software system architecture for knowledge management of several analysis tools used for product development;

FIG. 2 is a flow chart for a risk management process using one or more analysis tools while referencing design and specification requirements;

FIG. 3 is an exemplary block topology of a management system for cascading product requirements while implementing a user interactive display system;

FIG. 4 is a flow chart for a management system and process that populates requirements to several product related documents;

FIG. 5 is a block flow diagram illustrating a preferred implementation of requirements being communicated in accordance with one embodiment or aspect of the present disclosure;

FIG. 6A is an example GUI for identifying the safety goal and related functional safety requirements based on voice of customer, and hazard analysis risk assessment;

FIG. 6B is an example GUI for identifying item requirements based on voice of customer;

FIG. 6C is an example GUI for identifying the technical safety requirement(s) related to each functional safety requirement(s);

FIG. 7 is an example of a cross reference population of one or more elements from at least one document illustrated as a top down analysis report; and

FIG. 8 is an example GUI which is the result of a computer system populating requirements to generate and display a fault tree analysis.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Engineers may use several spreadsheets to identify and analyze risks associated with their designs and processes. The spreadsheets may be developed to include several analysis tools including, but not limited to, hazard analysis risk assessment, the eight discipline problem solving method steps (or analogous problem solving strategy), design of experiments, fault tree analysis, tolerance design, quality function deployment and/or categories to determine a proper failure mode and effects analysis. A software application may be designed to implement one or more analysis tools to ensure a consistent organized approach when completing the analysis method.

The software application may implement the one or more analysis tools while also managing engineering design records and specification requirements for the one or more products that an engineering organization may be developing. The engineering design records and specification requirements may be managed by using the production part approval process (PPAP) method and/or the advanced product quality planning process (APQP) designed to ensure that a product is consistently meeting requirements during an actual production run. The PPAP and APQP methods ensure that suppliers and OEMs have properly understood all the design and specification requirements for one or more components and that the process has the capability to consistently deliver products that comply with those requirements.

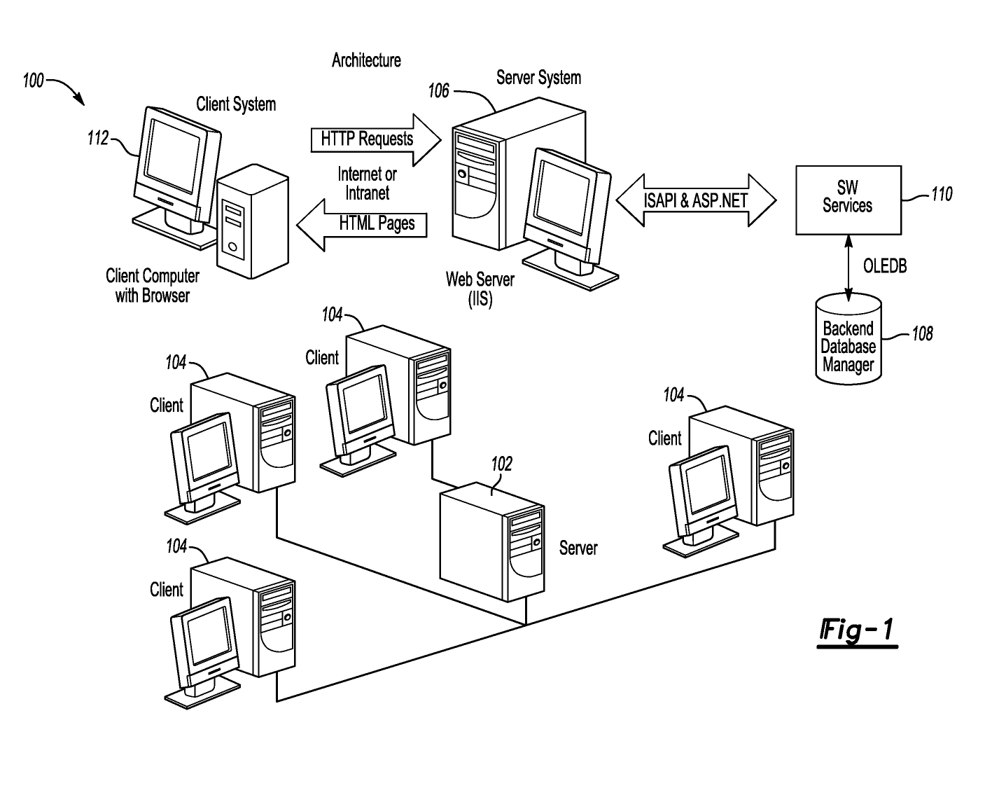

In one embodiment, as shown in FIG. 1, is a diagram of a web-based software system architecture for knowledge management of requirement documents, several analysis tools, and problem solver methods used for product development. The web-based software system 100 may include a management method that integrates requirements, PPAP and/or APQP documents while allowing one or more analysis tools to be implemented while enabling data sharing between documents.

For example, the system architecture may be a web-based software working over an internet and/or intranet allowing worldwide access to one or more facilities across the globe. The primary requirements of the sites are that they have access to the host location. The software resides on the host location which is located on a customer server with access to a SQL manager and any computer that has a browser with access to the internet and/or intranet. The system architecture may allow a user to create an enterprise specific knowledge bank allowing for customized reports to meet a specific customer requirement and also provide a detailed revision history on all requirement, specification, PPAP, APQP, and/or analysis tools documentation.

The system architecture 100 network diagrams may include, but is not limited to, a server 102, one or more processors, one or more client systems 104, and software that may be designed to be a standalone system. The one or more client systems 104 may be located at an individual user site having a single office, or several offices globally located.

The system architecture 100 may include, but is not limited to, a webserver 106, a database 108, knowledge management software 110, and one or more client systems 112. The webserver 106 having a processor, RAM, a hard disk drive, and the necessary server software. The database system 108 may include, but is not limited to, a relational database management system (e.g. Microsoft SQL server) having a processor, RAM, a hard disk, and an operating system software. The one or more client systems 112 having at least a processor, RAM, browser, and internet/intranet software requirements.

The knowledge management software 110 may be a standalone design using only a database system as the backend database manager. The knowledge management system software may include application programming interfaces (APIs) allowing software components to interact with each other. The knowledge management system software may communicate with other software via a set of rules for encoding documents in a format that is both human-readable and machine-readable (e.g. extensible markup language (XML)). The software may include, but is not limited to using and/or creating: product and process requirements, malfunctions and failure modes of the requirements, effects of the failure modes, preventive controls, detective controls, recommended actions and implementation timings, control (test and detection activities) implementation details and results, project timings and supporting documentation, product details related to FMEAs, problem details related to global 8D method, risk analysis displayed as a fault tree, and final solution and validation results.

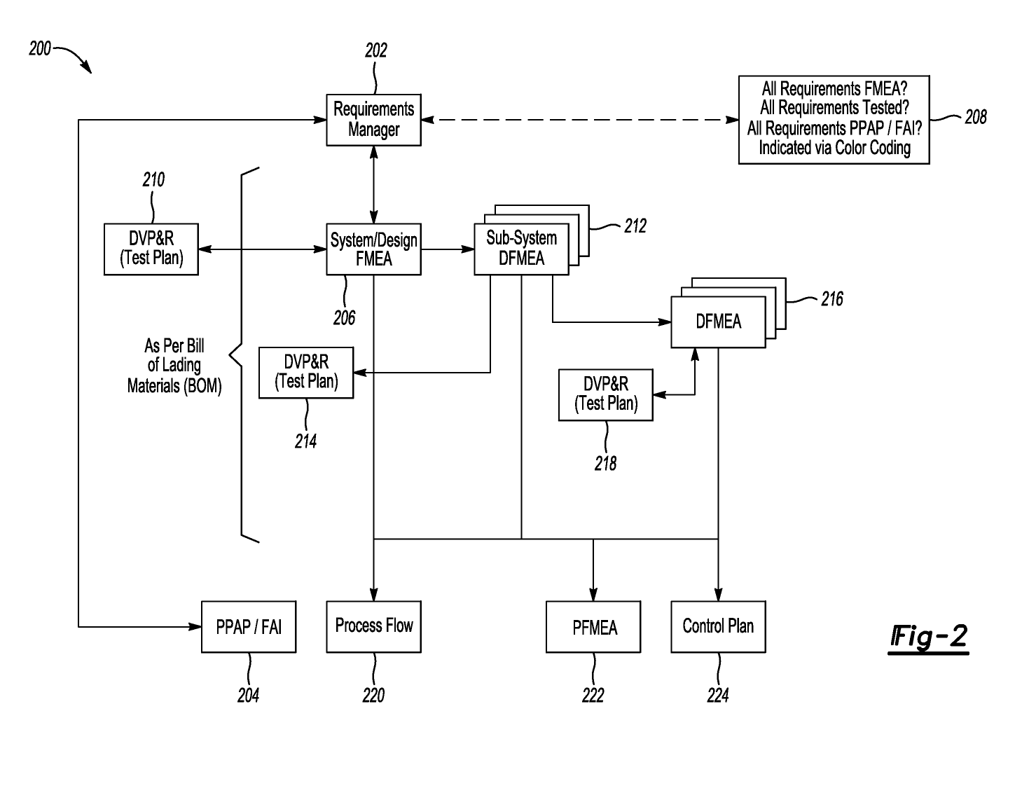

FIG. 2 is a flow chart for a risk management process 200 using one or more analysis tools while referencing design and specification requirements. The one or more analysis tools may include, but is not limited to, system and/or design FMEAs; design verification plan and report (DVP&R); first article of inspection (FAI); and/or a hazard analysis risk assessment (HARA). The design and specification requirement documents may include, but is not limited to PPAPs, APQPs, and/or a first article of inspection (FAI). The requirement documents may also include, but is not limited to, function requirements, technical requirements, hardware requirements, software requirements, and/or hardware-software interface requirements. The FAI may include, but is not limited to, testing results of production parts to determine if the product meets acceptance requirements and quality control requirements.

At step 202, the requirements manager may be displayed to one or more client system computers and allows a user access to all analysis results and requirements. The requirement manager may receive PPAP, APQP, and/or FAI information at step 204. The risk management process may receive the requirements from one or more users at a client computer. The requirement manager may receive one or more FMEA(s) analysis information at step 206. The risk management process may allow a user to access and administer an FMEA at one or more client computers. The risk management process may generate one or more cross-reference matrices based on the information received by the requirement manager.

At step 208, the requirements manager may present the cross-reference matrices based on the analysis and requirements information to a user using several formats including, but not limited to, a parent-child structure, a fault tree analysis, and/or a dashboard display. The dashboard display may present all requirements with the respective analysis done in the FMEA and/or 8D based on user defined relationships of color coding on what is complete and pending. For example, the dashboard may let a user know if all the requirements have been analyzed in the FMEA using color coding. In another example, the dashboard may also present information related to the testing results of all the requirements and/or present all the PPAP requirements related to the FIA.

At step 206, the requirements manager is able to replicate the product requirements into one or more FMEAs. The product requirements may include, but is not limited to, PPAP and/or APQP. The one or more FMEAs may include, but is not limited to, design and/or system FMEAs. The process allows information to be entered automatically eliminating the need to rework, re-enter, edit, and/or review multiple analytical tool documents/spreadsheets. The requirements generated into FMEAs may be all or only safety product requirements.

At step 210, the process may allow the FMEAs to be compared and analyzed to the several test performed on the product. The several tests performed on the product may be summarized using a design verification plan and report form (DVP&R). The DVP&R is a summary of every test performed on the product and/or system, and identified in the related system or design FMEA. The DVP&R may include, but is not limited to, each individual test, when the test was performed, the requirement tested, results, and if the test(s) passed/failed. The DVP&R allows for the product/system bill of materials to be listed with the requirements to show compliance to the specification. Typically the DVP&R are reviewed and signed off by both customer and supplier engineering groups.

At step 212, the process may develop a subsystem FMEA to determine the cause and effect relationship between that subsystem and the product/system as a whole. The subsystem FMEA may include a design FMEA. The process may allow the subsystem FMEA to be compared, correlated, and analyzed to the subsystem DVP&R at step 214. The subsystem DVP&R may include, but is not limited to, each individual test performed on the subsystem, the requirement tested, results and if the test(s) passed/failed. The DVP&R information is transmitted and correlated with the subsystem FMEA.

At step 216, the process may also develop a component FMEA which may be embedded in the system/product and/or the subsystem. The component FMEA may include a design FMEA. The process may allow the component FMEA to be compared, correlated and analyzed to the component DVP&R at step 218. The component DVP&R may include, but is not limited to, each individual test performed on the component, the requirement tested, results and if the test(s) passed/failed. The component DVP&R information is transmitted and correlated with the component FMEA.

At step 220, a process flow diagram is generated based on the general flow of the manufacturing and/or assembly process and equipment based on the product. The process flow diagram displays the relationship between the equipment and/or assembly operation of processing the product.

At step 222, a process FMEA is generated that includes analysis of a sequence of tasks that is organized to produce a product or provide a service. The process FMEA can involve analysis with several sequences of tasks including, but not limited to, fabrication, assembly, transactions, or services.

At step 224, a control plan is generated to keep track of the status of all significant process characteristics. The control plan is used in developing controls against unfavorable outcomes in a manufacturing process. Based on the FMEAs, the control plan determines what steps to take if a specific failure becomes apparent and is a tool to control and contain warrant issues. The control plan may also be used as a tool to coordinate future and ongoing process improvement activities.

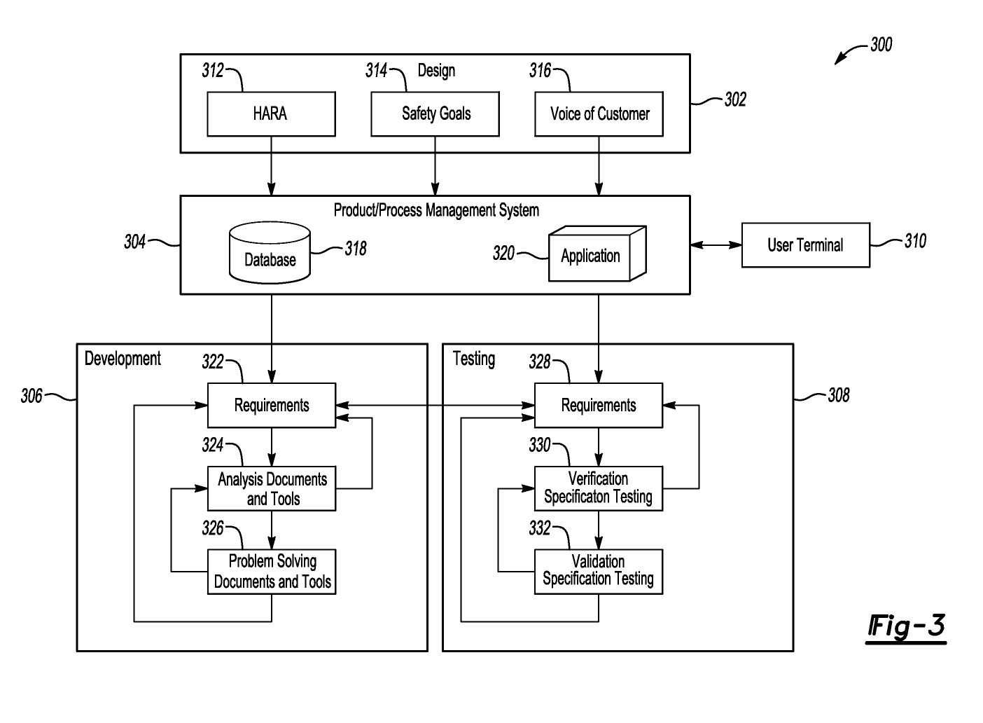

FIG. 3 is an exemplary block topology of a system 300 for cascading product requirements while implementing a user interactive display. The management system may facilitate one or more products and/or processes from receiving design requirements, generating development documents, cross-referencing the requirements, and providing testing reports to ensure that the specifications and requirements have been met. The system 300 allows for a user to interact with the system from a local terminal and/or a remote location several thousands of miles away.

The product/process management system 304 may include one or more algorithms 320 associated with communicating requirements, generating design documents, and populating test reports that cross-reference the requirements. The product/process management system 304 may have a database 318 located locally with the application or in a remote location that communicates with the system. The product and process management system may allow a user terminal 310 several controls of the system including, but not limited to, submitting requirements, updating documents, generating problem solving tools (e.g. fault tree analysis), and/or other product development tools.

The product and/or process management system 304 may receive design specifications and requirements 302 including, but not limited to, Hazard Analysis and Risk Assessment (HARA) 312, safety goals 314, and/or voice of customer requirements 316. The voice of the customer (VOC) requirements may include, but is not limited to, customer's expectations, preferences, and aversions. The HARA may include, but is not limited to, requirements that have been identified as a hazard for a potential condition that may or may not exists in the product or process, and provides the determined risk assessment to identify the types of hazard(s). The safety goals may include, but are not limited to, requirements and/or specifications based off the HARA analysis while certifying the VOC are met.

The product and/or process management system 304 may have one or more software programs to generate development documents and tools 306 that cross reference the one or more requirement 322 documents including, but not limited to, the HARA, safety goals, and VOC. The development tools 306 and documents may include, but is not limited to, analysis documents 324, problem solving documents 326, and/or any other development documents or tools used during product development and production. The analysis documents and/or tools 324 include, but are not limited to, failure mode and effects analysis (FMEAs), design verification plan and report (DVP&R), first article of inspection (FAI), fault tree analysis, and/or hazard analysis risk assessment (HARA). The problem solving documents and tools 326 may include, but is not limited to, FMEA, 8D, A3, 5 Why, fault tree analysis, and/or a design of experiment (DOE). The system allows for cross referencing of the requirements 322 to the analysis tools/documents and problem solving methods.

The product and/or process management system 304 may have one or more software programs to generate testing documents 308 that cross reference the one or more requirements 328 documents including, but not limited to, the HARA, safety goals, and VOC. The testing documents 308 may include, but is not limited to, verification specifications testing 330, validation specification testing 332, and/or any other testing documents and/or tools used during product development and production. The verification plan may include a test plan in a design stage of the product and a control plan in manufacturing of the product. The system generates and manages a cross reference of requirements in the verification and validation specification testing documents and reports. The verification specification testing documents allow a user developing a product and/or process to test during development of the product and/or process. The validation specification testing documents allow a user developing a product and/or process to test the product and/or process to ensure that it is ready for production.

During development and testing, the system may update requirements based on analysis, problem solving, and/or test results. The system allows the updated requirements to be communicated between the development requirements 322 and testing requirements 328 documents, reports and tools. The one or more users, with the use of a user terminal 310, may manage the requirements, documents, reports and tools.

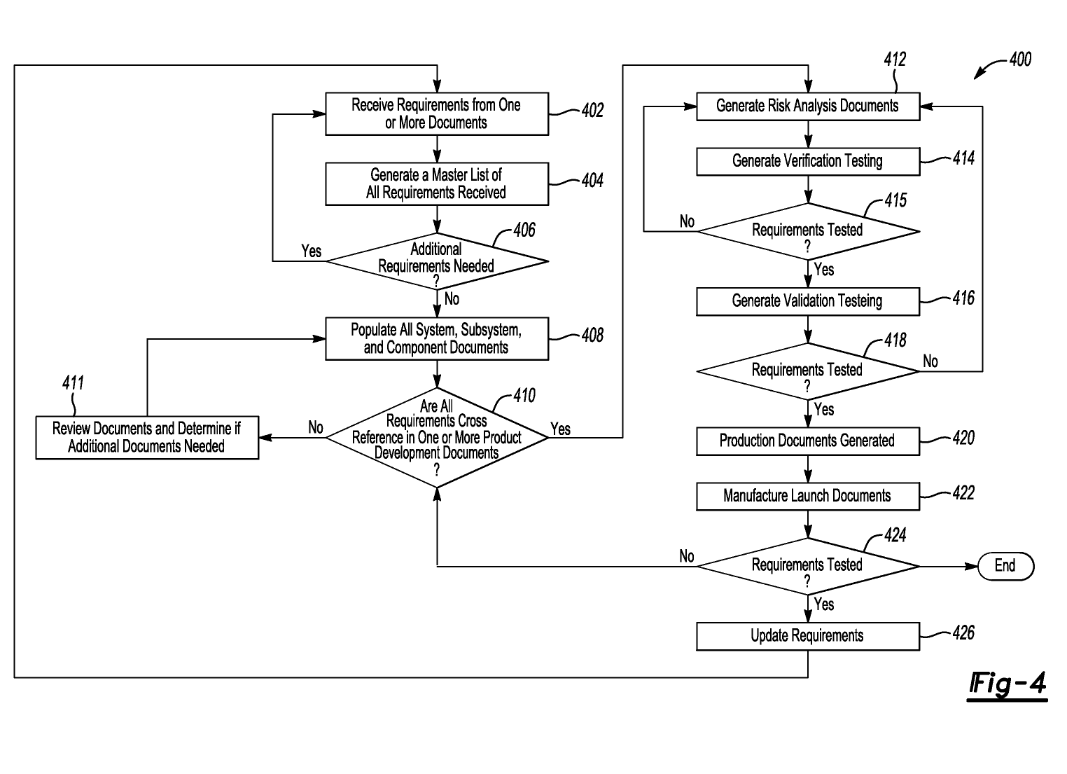

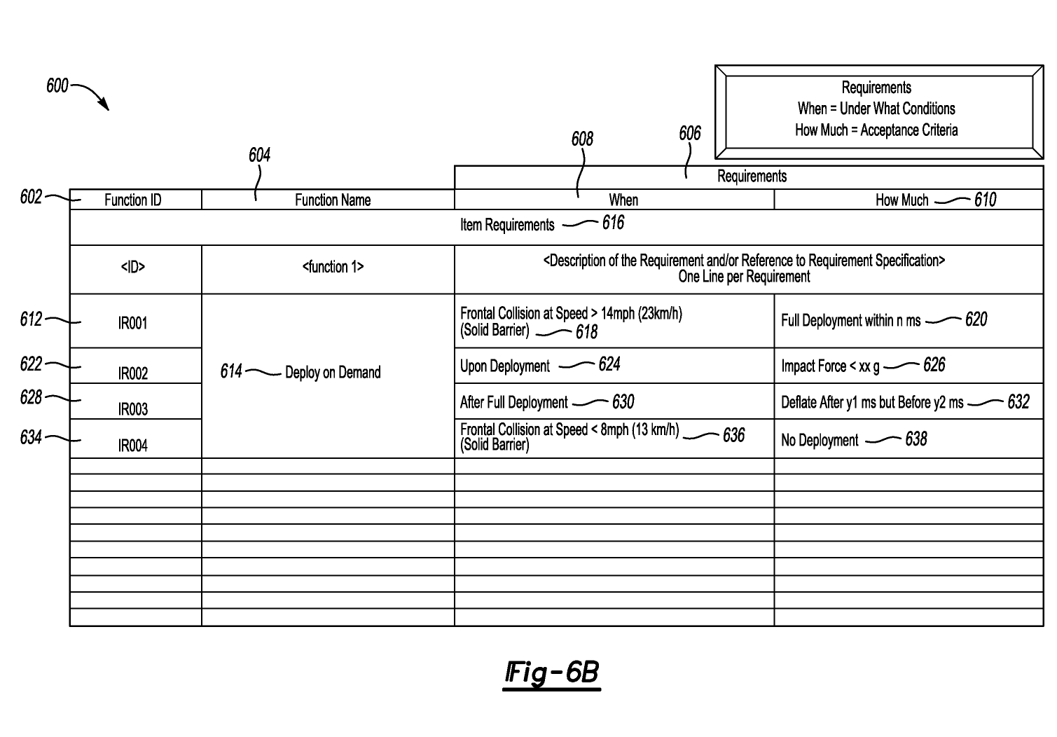

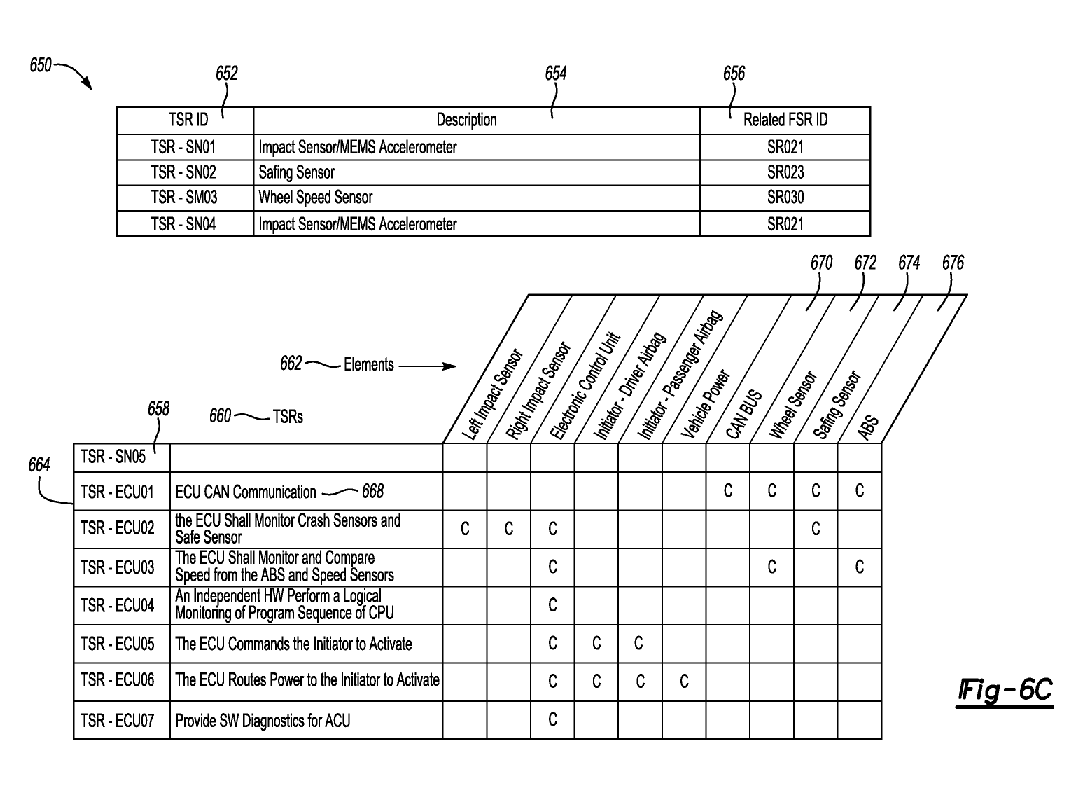

FIG. 4 is a flow chart for a management system and process that populates requirements to several product related documents. The flow chart in FIG. 4 may include the screen shots and user interfaces illustrated in FIGS. 6-8 which are referenced throughout the discussion of the method to facilitate an understanding of various aspects of the present disclosure. The method of communicating requirements to one or more risk analysis documents (e.g. fault tree analysis) may be implemented through a computer algorithm, machine executable code, or software instructions programmed into a suitable programmable logic device(s) of a computer system, such as the processor, or a database in communication with computer system, or a combination thereof. For example, one or more processors may have additional instructions to implement several features of the product and/or process management system. Although the various steps shown in the flowchart diagram 400 appear to occur in a chronological sequence, at least some of the steps may occur in a different order, and some steps may be performed concurrently or not at all.

At step 402, the system may receive requirements from one or more documents including, but not limited to, a HARA, a component hardware/software technical requirements, system requirements, and/or subsystem specification/requirements. The system may receive these requirements through one or more user terminals in remote/local communication with the system. The system may have a database which stores these requirements and allocates them based on a certain product and/or process that the requirements are written to.

At step 404, the system may generate a master list of all requirements received based on a certain product, process, system, subsystem, and/or component. The master list may identify requirements that may be missing by allowing a user to ensure all necessary requirements are received. The system may notify a user that additional requirements are needed, and/or that the master list has been updated because additional requirements have been received at step 406.

At step 408, the system may populate all system, subsystem, and component documents of the product and/or process with their respective requirements. The system may ensure that all of the requirements on the master list are cross referenced in one or more development documents and/or test documents at step 410. If the system has not cross referenced all the requirements with one or more development documents or test documents, then the system may prompt the user to determine if additional development/test documents are needed at step 411.

At step 412, the system may allow a user to generate one or more risk analysis and problem solving documents including, but not limited to, a fault tree analysis. The system may allow one or more users to manage, update, and change the risk analysis and problem solving documents. The system ensures that requirements are populated in all product and/or process development tools used during development and production.

At step 414, the system may generate verification test documents and reports that are cross referenced with the one or more requirements related to the product/process being tested. The system may report the requirements that have been verified to a user at step 415. If the requirements have failed testing, or have not been tested, the system may generate one or more risk analysis documents to determine the severity of the non-pass/non-tested requirement(s). The system may provide a verification report to a user providing a status of the development of the product/process based on the requirements and test results.

At step 416, the system may generate validation test documents and reports that are cross referenced with the one or more requirements related to the product/process being tested. The system may report the requirements that have been validated to a user at step 418. If the requirement(s) have failed during validation, or have not been tested, the system may generate one or more risk analysis documents to determine the severity of the non-pass/non-tested requirement(s). The system may provide a validation report to a user providing a status if the product/process is ready for production based test result(s) crossed referenced with the respective requirement(s).

At step 420, the system may generate production sign-off documents based on the validation and verification of the product/process requirements. The system may also manage and/or generate several manufacture launch documentation regarding part runs, quality checks, and/or part inspections. The system may ensure all requirements have been tested before allowing a product into production at step 424. If all the requirements have not been tested, the system may check to see if all requirements have been cross referenced in one or more product development documents at step 410. The system may determine that a one or more requirements have not been tested and generate the respective validation and/or verification documents.

At step 426, the system may update the requirements based on the risk analysis, test results, and/or problem solving results and documents. The systems update of requirements may include, but is not limited to, amending requirement language, adding additional requirements, and/or deleting requirements. During the life cycle of the product/process, the system may continuously update the requirements and the cross-reference matrices that generate/populate documents for the product and/or manufacturing process. The system may share lessons learned by allowing a user to transmit requirement, risk analysis, and/or test results from one product (parent product) and communicate the information to other related manufacturing processes and/or products (child application) to update their respective requirements and other documents stored by the system.

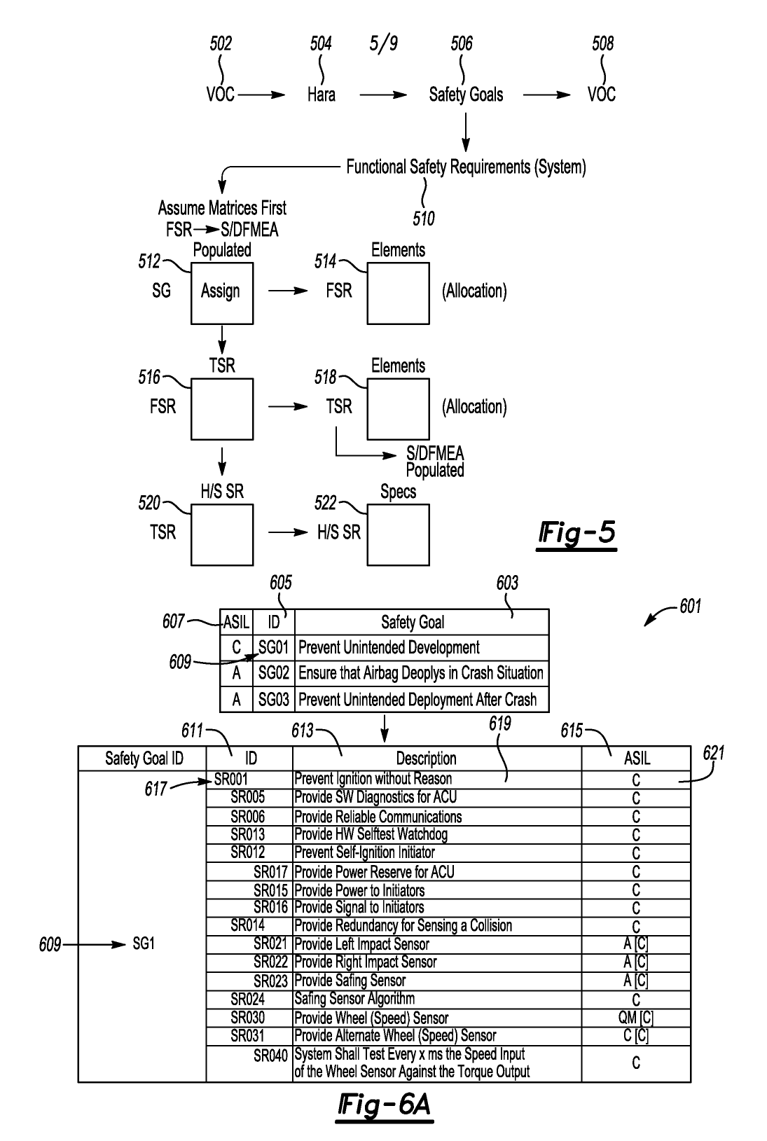

FIG. 5 is a block flow diagram illustrating a preferred implementation of requirements being communicated in accordance with one embodiment or aspect of the present disclosure. The system allows one or more users to define the architecture (structure) of the product (e.g. service, product, and/or process) to include the next layer of contributory elements. This may be done graphically or via a table; if by graphics, a companion table version is maintained and converse. The user defines the functions and requirements of the product (or service). These are allocated and/or linked to the elements in the architecture containing one or more risk analysis, development, and problem analysis tools, reports and/or documents.

For example, the system may generate a fault tree analysis based on a feature or function of the product. The user may select from a table of possible malfunctions for each functional requirement(s) and define the related failure mode (what may exist if the requirement is not met). In the fault tree analysis, if the risk analysis is focusing on safety, the system may initiate a Hazard Analysis and Risk Assessment (HARA). One or more users on the team may identify the effect of the identified malfunction/failure mode for situational scenarios selected form a table. This effect may have a default index for use in a risk calculation which may be overridden by the user. If the item being investigated has a child-parent relationship with another product (service), the effect of the child failure mode can be linked with one of the parent's failure mode and the parent's failure mode and its effects (and index) may become part of the child's effect and index. Based on the HARA result, the system may allow the team to identify: safety goals for the item being analyzed, functional safety requirements to achieve the safety goals and/or the allocation of these elements to other product documents. The allocation of these elements constitutes the item and technical safety requirements to achieve the functional safety requirements.

The hardware, software, and other requirements to achieve the technical safety requirements and the allocation of these elements which constitute the item are show in FIG. 5. The Functional Safety Requirements, Technical Safety Requirements, Hardware, Software and other Requirements are transferred to the general risk analysis software tool. For a general risk analysis, the team may continue to analyze the design/process using one or more terminals in communication with the system. The user may identify possible causes for each failure mode and the likelihood of occurrence for each using one or more risk analysis or problem solving tools such as a fault tree analysis. Other related information can be identified by the user as affecting the risk of the product (service). These can include the likelihood of preventing the cause before it occurs; likelihood of detecting the cause or failure mode, if it occurs; and controllability of the effect if the failure mode occurs. The team may use this information to determine what is necessary to prevent or mitigate potential risks.

At step 502, the system may receive voice of customer (VOC) requirements from one or more users at several terminals that may at different facility locations. The system may generate a HARA based on the one or more voice of customer requirement to see if the product, process, system, subsystem, and/or component have a hazard at step 504. The system may allow one or more users to review, update, and/or manage the HARA.

At step 506, the system may generate one or more safety goal based on the HARA analysis. The system allows one or more members of a production team to review, update, and/or manage the safety goals document. The system may generate cross-reference matrices that include the safety goals from the HARA with the one or more voice of customer requirements at step 508.

At step 510, after one or more users have reviewed the functional safety requirements (FSR), the system may format the FSR for downstream transmittal to several product/process documents including, but not limited to, development, technical safety, validation, verification, and/or specification documents. The system may transmit the FSR to one or more risk analysis tools/documents including, but not limited to, system failure mode effects analysis, and a design failure mode effects analysis document at step 512. The system may allocate the FSRs to the responsible organization, team, and/or individual who may be assigned responsibility for the requirement(s) at step 514. For example, the different elements/features in the product may have their respective functional requirements allocated to the hardware, software, subsystem, component, and/or integration team responsible for delivery of that element/feature.

At step 516, the system may communicate and transmit the FSR to one or more technical safety requirements (TSR) for a system, subsystem, and/or component. The technical safety requirements may be developed for each system, subsystem, and/or component based on identification of voice of customer's requirements, analysis of hazards, and remedial requirements to satisfy VOC and hazard analysis. The system may begin allocation of the technical safety requirements to one or more risk analysis or problem solving tool(s) at step 518. For example, the system may generate a subsystem FMEA based on that subsystem's technical safety requirements.

At step 520, the system may communicate and transmit the technical safety requirements to one or more hardware/software safety requirements document (H/S SR). The hardware/software safety requirements are more specific to a certain component, function, and/or feature. The system may allocate each technical safety requirement to the respective H/S SR subsystem, subcomponents, and/or component at step 522. For example, a physical component may have a specific requirement based on a VOC and/or HARA that the system may assign and assure that the requirement is communicated to the appropriate document during development, testing, product launch, and warranty analysis.

An example of the system communicating a VOC requirement may include, but is not limited, to a customer requirement stating that a vehicle must stop at 60 MPH within 200 feet. For the vehicle to achieve this requirement the signal from the driver's brake must be transmitted to the brake control module, and then from there a vehicle system has to be designed to stop the vehicle within the voice of the customer's requirement. The management system may communicate and transmit the VOC to function safety requirements that identifies that the vehicle must meet this requirement. The management system may recognize the vehicle requirement and provide a brake system technical safety requirement that documents this VOC want and/or need. The management system provides linkages between the specification and requirements while also identifying what testing may have to be done. The management system may assure that all customer needs are documented, tested, and satisfied.

FIG. 6A is an example GUI for identifying the safety goal and related functional safety requirements based on voice of customer, and hazard analysis risk assessment. The requirement management system may allow one or more users to generate function and requirement documents including, but not limited to, a system, subsystem, component, function, and/or specific feature. The requirement management system may allow for several users to update the document while managing changes and communicating the requirements to other related documents including, but not limited to, technical safety requirements, problem solving documents, risk analysis documents, and/or hardware/software safety requirements.

The system functions and requirements GUI 601 allows a user to manage several functions that may be based on one or more VOC and/or HARA requirements. For example, the system may populate one or more safety goals 603 based on a user input that includes, but is not limited to, a VOC and/or HARA. For example, the system may generate one or more cross-reference matrices that analyze VOC requirements and a HARA analysis to determine a vehicle feature safety goal 603 related to an automotive safety integrity level (ASIL) assignment 607. The system may also assign an identification number (ID) 605 to the safety goal 603 that may be used for cross-referencing to other documents that may reference the safety goal allowing the system to link the requirement. The other document that may be linked to the safety goal 603 ID 605 may include, but is not limited to, functional safety requirements, technical safety requirements, hardware/software safety requirements, and/or risk prevention analysis documents.

The system may generate a function safety requirement 609 file based on a safety goal 603 file. For example, the safety goal SG01 609 may identify the VOC to prevent unintended deployment of an airbag. The system may generate cross-reference matrices of several related child requirements 611 that have a parent-child relationship with safety goal SG01 609 listed as child identification ID 611 with their respective ASIL 615 based on one or more requirement documents and HARA analysis. For example, a requirement that may potentially cause a top level event may be a classified as a child by the computer system. The top level event illustrated in FIG. 6A may include safety goal SG01 to prevent unintended deployment of an airbag. The concern that may cause the unintended deployment of an airbag 609 may be an ignition by the airbag control module without reason 619 under safety function requirement SR001 617. The system may generate a parent-child analysis with the respective assigned ASIL to give one or more users the ability to see the correlation between the safety goals of a product, system, and/or component.

FIG. 6B is an example GUI for identifying item requirements based on voice of customer. In this GUI 600 illustrative example the system may communicate the function ID 602, function name 604, and/or requirements 606. The requirements may include several subsections including, but not limited to, when 608 the requirement is needed based on certain condition(s), and/or how much 610 of a range is an accepted criteria to meet that requirement condition(s).

The GUI 600 interference documents the item requirement(s) 616 allowing for a description of the requirement and/or reference to a requirement specification on each line. For example, a vehicle may have a supplemental restraint system (SRS) that includes, but is not limited to, controlling deployment of an air bag in the vehicle upon detection of a collision. The first item requirement document under function ID may be given a cross-reference number, for example IR001 612, so that the requirement management system may manage this item requirement and communicate it with other documents.

The Function ID 602 IR001 612 is based on a function of deploy on demand 614 for the SRS controller of the one or more air bags in the vehicle. The function to deploy on demand the one or more airbags may be initiated under several requirement 606 conditions including, but not limited to, when 608 the frontal collision of the vehicle is at a speed greater than 14 MPH (solid barrier) 618. The acceptable criteria for deployment of an airbag when the frontal collision for the vehicle is at a certain speed may have several acceptance criteria including, but not limited to, how much 610 full deployment of the one or more airbags must be within a certain amount of time 620. The requirement to initiate the airbag 618 and the acceptable criteria for deployment 620 may be communicate by the requirement management system to several development, test, risk analysis, and/or problem solving documents. The requirement management system may ensure that these item requirements 616 are cross-referenced in several development documents during product design of the airbag system and are tested during verification and validation of the SRS.

The Function ID 602 IR002 622 is based on another function of deploy on demand 614 for the SRS control of the one or more airbags in the vehicle. The function to deploy on demand the one or more airbags may be initiated under a requirement 606 condition that includes, but is not limited to, when 608 upon deployment of the air bag 624 the acceptable impact force may be a VOC/HARA defined value 626 that the vehicle system must meet. In another SRS requirement example, IR003 628 may contain the airbag full deployment 630 requirement of deflating after a VOC/HARA predefined amount of time 632. The SRS may have requirement function ID IR004 634 determine additional safety criteria based on one or more VOC and/or HARA requirements that state frontal collision speeds 636 so that the SRS may not deploy 638.

FIG. 6C is an example GUI for identifying the technical safety requirement(s) related to each functional safety requirement(s). The requirement management system may allow one or more users to generate technical safety requirement documents including, but not limited to, a system, subsystem, component, function, and/or specific feature. The requirement management system may allow for several users to update the document while managing changes and communicating the requirements to other related documents including, but not limited to, hardware and software safety requirements, problem solving documents, and/or risk analysis.

Referring again to FIG. 6C, an example GUI identifying the allocation of item requirements based on voice of customer, hazard analysis risk assessment, function safety requirements, and/or technical safety requirements to the elements of an item. The technical safety requirement 668 and related identification number 664 is allocated to the elements 670, 672, 674, and 676 from all the elements which make up the item 662. The ASIL related to the technical safety requirement is shown at the intersection of the TSR 660 and related element(s) 662.

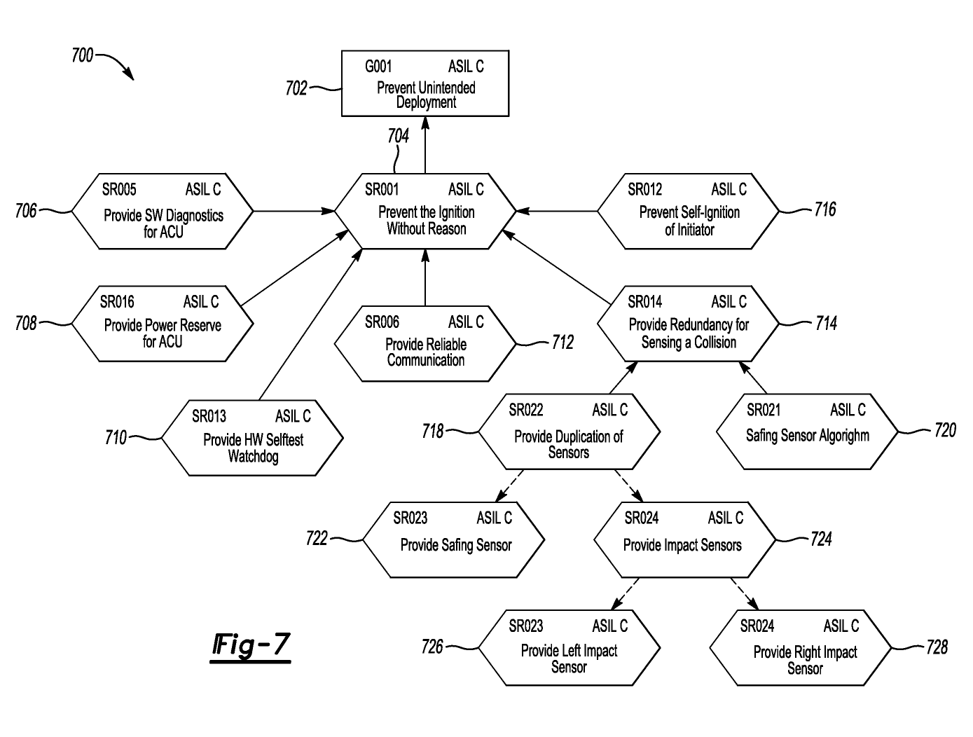

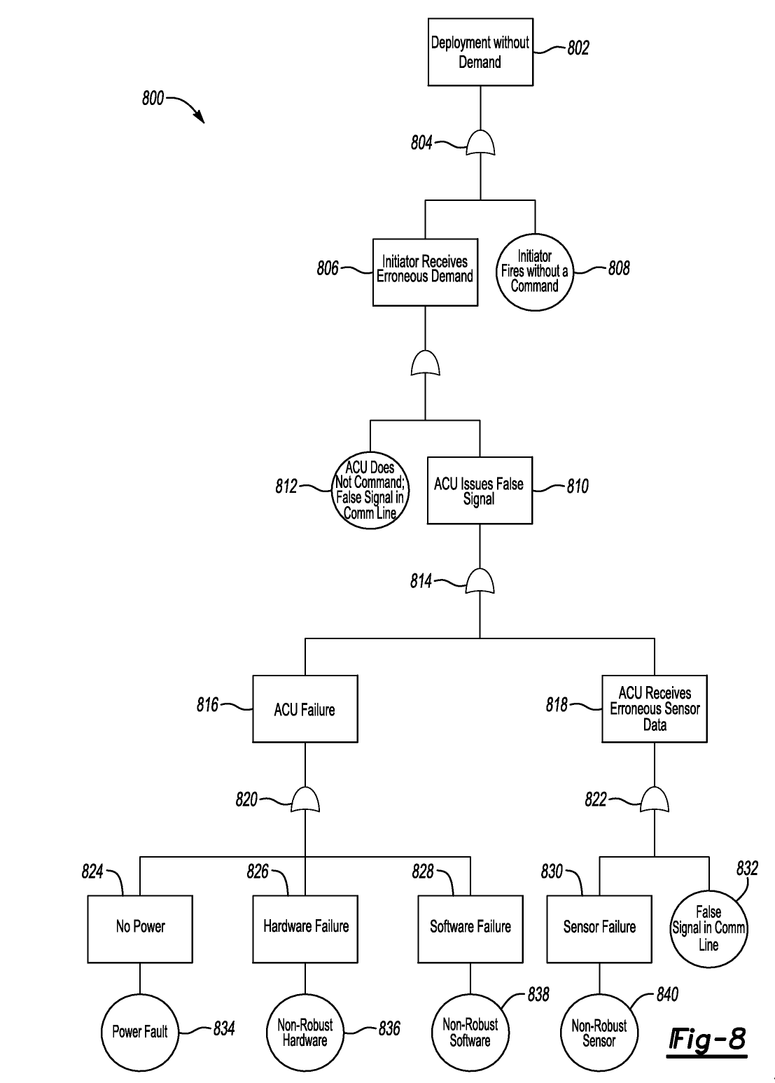

FIG. 7 is an example of a cross reference population of one or more elements from at least one document illustrated as a top down analysis 700 report(s). The at least one document may include, but is not limited to, a problem solver, risk analysis, functional safety requirements, HARA, and/or a technical specification requirements. The requirement management system may allocate the requirements in a top down approach allowing the system to determine if whether or not a requirement may be allocated based on subrequirements and/or super requirements. For example, a requirement does not necessarily have to be allocated if all of its subrequirements are allocated.

As the requirement management system generates a top down population approach cross referencing at least one requirement as illustrated in FIG. 7. The management system may contain several algorithms to control transmission of requirements between several documents while generating problem solving tools, risk analysis methods, and/or other top down requirement reports/documents.

For example, an airbag deployment system may have identified several requirements based on the HARA and/or VOC that may represent the performance of how the customer would expect the airbag deployment system to work. One requirement may include, but is not limited to, the customer wanting the airbag system to prevent unintended deployment 702. The requirement management system may allocate the airbag system prevent unintended deployment 702 requirement for further analysis under the HARA approach. The HARA may determine that the automotive safety integrity level (ASIL) of an unintended deployment of an airbag in a vehicle may be defined as an ASIL C which may have additional International Organization for Standardization (ISO) specifications and requirements needed for validation and verification during development and/or testing of the airbag system.

As shown, to prevent unintended deployment 702, the requirement management system may allocate a VOC requirement number, e.g. G001, to the requirement file. The requirement number may allow the management system to associate the VOC with several documents ensuring that the VOC is communicated and cross-referenced accordingly.

The VOC requirement to prevent unintended deployment of an airbag may be communicated to a safety restraint system, risk prevention analysis file, and/or vehicle system functional safety requirements document as to prevent the ignition of the airbag without reason 704. The functional safety requirement that address the unintended deployment of an airbag may be assigned a requirement number, e.g. SR001, to the safety requirement document. The functional safety requirement number may allow the management system to allocate the requirement to several documents ensuring that the requirement is communicated and cross-referenced accordingly.

The safety restraint module of the vehicle computing system requirement of preventing the ignition without reason 704 for airbag deployment may include several subrequirements. The subrequirements may be illustrated by the requirement management system in a top down approach to communicate the relation and hierarchy of the one or more requirements in the safety restraint module in communication with the vehicle computing system. The requirement management system may structurally communicate to a user of how one or more requirements may be interrelated. This may be beneficial during development, testing, and/or problem solving a product.

The subrequirements for the prevent the ignition of the airbag without reason requirement may include, but is not limited to, provide software diagnostic for airbag control unit (ACU) 706, provide power reserve for airbag control unit 708, provide hardware selftest watchdog 710, and/or provide reliable communication to safety restraint module 712 and vehicle computing system.

A subrequirement that may be illustrated as a primary requirement having several additional requirements includes, but is not limited to, providing redundancy for sensing a collision 714 so that that the safety restraint system may prevent an unintended deployment of the airbag. The secondary requirements that are related and/or integrated with redundancy for sensing a collision 714 includes providing duplication of sensor 718, and having a duel path sensor algorithm 720.

The duplication of sensor 718 requirement may be achieved by ensuring that an additional redundant sensor(s) 722 and impact sensor(s) 724 are in the safety restraint system that communicates/controls the airbag control unit. There may be two impact sensors 724 including a left impact sensor 726 and a right impact sensor 728.

The top down population of a VOC/safety function requirements illustrates how the management system may be able to generate visual reports that may assist a user during the development, testing, and problem solving of a product. The management system may allocate requirements that may have several subrequirements to allow the user to determine a visual to down understand of the interrelation of the requirements, components, and system operation of a product.

FIG. 8 is an example GUI which is the result of a computer system populating requirements to start a fault tree analysis. The computer system may receive one or more requirements that include, but is not limited to, VOC, HARA, and/or other documents that may set fourth requirements for a product, process, system, subsystem, and/or component. The system may generate several documents and specifications based on the received requirements used for product development and testing including, but not limited to, technical safety requirements, FMEAs, hardware/software safety requirements, fault tree analysis, problem solving tools, and/or functional safety requirements.

In one example, the system may generate a fault tree analysis which is a top down, deductive failure analysis in which an undesired state of a product/process/component is analyzed. The fault tree analysis uses Boolean logic to combine a series of lower-level elements that may contribute to the failure in the product/process/component. The computer system may generate, develop, and display the fault tree analysis method so that the main elements in the field of safety engineering and reliability engineering is used to understand how the product can fail, identify the best ways to reduce risk of failure, and/or to determine events in the analysis in which event rates of a safety accident may happen. The system may use the cross-reference matrices, and/or the one or more requirements to generate the elements in the fault tree analysis allow the user to view the parent-child structure ensuring that the functional safety requirements are being met during the development, testing, risk assessment, and/or problem solving of a product.

The system generating a fault tree allows a product to be visually broken down in a bill of material tree structure which may include, but is not limited to, the types of material used to build the product. The entire product is going to be made from requirements based on a system having one or more subsystems, and the subsystem made of one or more components. The computer system generating a fault tree starting off at top level illustrating a problem at a system level could be caused by a problem in one of the next levels down as you continue down the tree to one subsystem, and one of its components as illustrated in FIG. 8.

The manual assembly of a fault tree analysis can be a costly and cumbersome experience, therefore having a computer system generate a fault tree for several products including, but not limited to a system, subsystem, process, and/or component may allow for less error in the analysis. The computer system may generate a fault tree analysis based on the cross-referencing and allocation of several requirement documents, problem solving tools, and/or risk analysis documents and results. The system may link elements between the one or more documents to automatically update the related elements in each respective document when changes are made and allows the system to understand how the requirements relate in accordance to hierarchy and function to each other.

For example, the computer system may generate a fault tree analysis based on a safety goal requirement of deployment of the airbag without demand 802. The fault tree top event 802 may have several concerns down from it including, but not limited to, other subsystems and/or components that may cause the fault in the top event. Each concern that could cause that effect of the fault tree top event is added to the fault tree as a series of logic expressions. The computer system may generate each concern based on the hierarchy of the requirement and/or how the requirement interrelates/function with the fault tree top event.

In our example, the computer system may have the safety restraint system, communicating with a vehicle computing system, initiator receive an erroneous demand 806 or a basic event failure/error in a system/component 808 may cause deployment of the airbag without demand 802. The system may receive this concern based on one or more risk analysis documents that are related with the fault tree top event. The computer system may further generate another concern based on a risk prevention analysis document, requirement document, and/or risk analysis tool that the initiator receives an erroneous demand from the airbag control unit transmitting a false signal 810 or a basic event failure/error in the ACU system/component 812 may be sent to the initiator causing unintentionally deployment of the airbag.

The computer system may determine that there may be two concerns that may cause an ACU to issue a false signal 810 initiating unintended deployment of an airbag including an ACU failure 816 or an ACU receives erroneous sensor data 818. The computer system may further elaborate additional elements/concerns that may cause an ACU failure 816 including no power 824, hardware failure 826, and/or software failure 828. The computer system may further elaborate on an element that may cause an ACU receiving erroneous sensor data 818 from a sensor failure 830.

The computer system generation of a fault tree analysis may allow one or more user to visual scroll through the analysis of a system, subsystem, and/or component on a display. The display may include, but is not limited to, a computer terminal screen, laptop, and/or tablet. The fault tree analysis top event and the several concerns listed below may include requirement number associated with the concern. The computer system may link the concerns with one or more documents to allow for updates and/or changes to be communicated to all related documents. The computer system may also allow other risk assessment document, problem solving document, and/or requirement documents to be launch from the fault tree analysis document based on a linked element.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A non-transitory machine readable storage medium storing instructions that, when executed, cause a processor to perform a method comprising:
receive input defining one or more requirements for a product;
generate one or more cross-reference matrices from the one or more requirements based on an hazard analysis risk assessment;
generate a parent-child structure for the one or more cross-reference matrices;
populate a requirement file based on the cross-reference matrices;
generate a risk prevention analysis file based on input from the requirement file and one or more linkages between the one or more requirements and the parent-child structure; and
output the risk prevention analysis file, including a tree structure and a tool to enable a user to scroll through the tree structure.

2. The non-transitory machine readable storage medium of claim 1 storing additional instructions, when executed, causes a processor to update the requirement file, risk prevention analysis file, and parent-child structure using the one or more linkages based on input from a user.

3. The non-transitory machine readable storage medium of claim 2 wherein the inputs are received at a user terminal.

4. The non-transitory machine readable storage medium of claim 1 wherein the one or more requirement is voice of customer wants and needs.

5. The non-transitory machine readable storage medium of claim 1 wherein the requirement file is a functional safety requirements document.

6. The non-transitory machine readable storage medium of claim 1 wherein the requirement file is a technical safety requirements document.

7. The non-transitory machine readable storage medium of claim 1 storing additional instructions, when executed, causes a processor to display the tree structure as a fault tree analysis.

8. The non-transitory machine readable storage medium of claim 1 wherein the risk prevention analysis file includes failure mode and effects analysis, global 8D, A3, 5 Why, fault tree analysis, and a design of experiment.

9. The non-transitory machine readable storage medium of claim 1 wherein the output of the tree structure may be analyzed top down or bottom up on a display.

10. The non-transitory machine readable storage medium of claim 1 storing additional instructions, when executed, causes a processor to populate a product and process verification plan based on the risk prevention analysis file.

11. The non-transitory machine readable storage medium of claim 10 wherein the product and process verification plan is a test plan or a control plan.

12. A system comprising:
one or more processors configured to:
receive input defining one or more requirements for a product;
generate one or more cross-reference matrices from the one or more requirements;
generate a parent-child structure for the one or more cross-reference matrices;
populate a requirement file based on the cross-reference matrices;
generate a risk prevention analysis file based on input from the requirement file and one or more linkages between the one or more requirements and the parent-child structure; and
output the risk prevention analysis file.

13. The system of claim 12 wherein the output risk prevention analysis file includes a tree structure and a tool to enable a user to scroll through the tree structure.

14. The system of claim 13 wherein the tool is located next to the tree structure as a scrollbar.

15. The system of claim 12 storing additional instructions, when executed, causes a processor to update the requirement file, risk prevention analysis file, and parent-child structure using the one or more linkages based on input from a user.

16. The system of claim 12 storing additional instructions, when executed, causes a processor to populate a product and process validation plan based on the risk prevention analysis file.

17. The system of claim 12 wherein the one or more requirement is voice of customer wants and needs.

18. The system of claim 12 wherein the requirement file is a hardware software safety requirements document.

19. A method comprising:
receiving input defining one or more requirements for a product;
generating one or more cross-reference matrices from the one or more requirements based on at least one design specification;
generating a parent-child structure for the one or more cross-reference matrices;
populating a requirement file based on the cross-reference matrices;
generating a risk prevention analysis file based on input from the requirement file and one or more linkages between the one or more requirements and the parent-child structure; and
outputting the risk prevention analysis file, including a tree structure and a tool to enable a user to scroll through the tree structure.

20. The method of claim 19 further comprising updating the requirement file, risk prevention analysis file, and parent-child structure using the one or more linkages based on input from a user.

21. The method of claim 19 further comprising displaying the tree structure as a fault tree analysis.

22. The method of claim 19 wherein the risk prevention analysis file includes failure mode and effects analysis, global 8D, A3, 5 Why, fault tree analysis, and a design of experiment.

23. The method of claim 19 wherein the output of the tree structure may be analyzed top down or bottom up on a display.

24. A non-transitory machine readable storage medium storing instructions that, when executed, cause a processor to perform a method comprising:
receive input defining one or more requirements for a product;
generate a parent-child structure for the one or more requirements;
populate a requirement file based on the input;
generate a risk prevention analysis file based on input from the requirement file and one or more linkages between the one or more requirements and the parent-child structure; and
output the risk prevention analysis file including a test plan in response to the one or more requirements.

25. The non-transitory machine readable storage medium of claim 24 storing addition instruction, when executed, causes a processor to generate one or more cross-reference matrices from the one or more requirements based on an hazard analysis risk assessment and populate the requirement file based on the cross-reference matrices.

26. The non-transitory machine readable storage medium of claim 24 wherein the risk prevention analysis file includes a tree structure.

27. The non-transitory machine readable storage medium of claim 26 wherein the tree structure includes a tool to enable a user to scroll through the tree structure.

28. The non-transitory machine readable storage medium of claim 24 wherein the test plan includes a verification plan.

29. The non-transitory machine readable storage medium of claim 24 wherein the test plan includes a validation plan.
